(19) United States
(12) Patent Application Publication
(10) Pub. No.: US 2026/0323525 A1
(43) Pub. Date: Oct. 15, 2026

(54) Dynamic Operation of Wireless Communication with Energy Harvest

(71) Applicant: Apple Inc., Cupertino, CA (US)

(72) Inventors: Haitong SUN, Saratoga, CA (US); Dawei ZHANG, Saratoga, CA (US); Haijing HU, Los Gatos, CA (US); Mona AGNEL, Guildford (GB); Naveen Kumar R PALLE VENKATA, San Diego, CA (US); Oghenekome OTERI, San Diego, CA (US); Wei ZENG, Saratoga, CA (US); Zhibin WU, Los Altos, CA (US)

(21) Appl. No.: 19/113,674

(22) PCT Filed: Sep. 14, 2023
(86) PCT No.: PCT/US2023/032713

§ 371 Date: Mar. 20, 2025

Related U.S. Application Data
(60) Provisional application No. 63/376,667, filed on Sep. 22, 2022.

(51) Int. Cl. H04W 52/02; H04L 5/00; H04W 4/80; H04W 72/1263

(52) U.S. Cl. CPC H04W 52/0296; H04L 5/0094; H04L 5/0096; H04W 4/80; H04W 52/0216; H04W 72/1263

(57) ABSTRACT

A user equipment (UE) configured to decode, based on signals received from a network, a first configuration for wireless communications with the network, wherein the wireless communications and associated processes are performed by a wireless communications module of the UE and powered by energy generated by an energy harvesting module of the UE, decode, based on signals received from the network, a second configuration for a scheduling restriction for energy harvesting comprising a duration during which some or all of the wireless communications with the network are suspended, during the duration of the scheduling restriction, reduce a power state for the wireless communications module and initiate energy harvesting operations by the energy harvesting module and after the duration of the scheduling restriction, restore the power state for the wireless communications module and stop the energy harvesting operations by the energy harvesting module.

### PRIORITY/INCORPORATION BY REFERENCE

This application claims priority to U.S. Provisional Application Ser. No. 63/376,667 filed on Sep. 22, 2022 and entitled “Dynamic Operation of Wireless Communication with Energy Harvest,” the entirety of which is incorporated herein by reference.

### BACKGROUND

A passive device can refer to a low-power device that does not require an external (electrical) power source to operate over its intended lifetime. Passive Internet of Things (IoT) devices can provide an alternative to other passive technologies including, e.g., radiofrequency identification (RFID). The passive IoT device can be designed to have a complexity and power consumption that is orders of magnitudes lower than existing 3GPP technologies and may operate either without a battery or with an internal energy storage that does not need to be replaced or recharged manually.

The passive IoT device may rely on energy harvesting to power the device, wherein energy can be generated from external sources such as an external RF field, light, heat, vibration, or other sources. By using energy harvesting, the device can operate for a long time (e.g., its entire lifespan) without needing external intervention or maintenance, e.g., without replacing or recharging a battery. However, in view of the need for low power consumption, the device may be constrained in terms of processing power, communication range, etc. Additionally, if the energy harvesting technology uses an external RF field as a source, the frequencies that can provide energy harvesting may be different from those required for communication. Thus, the device may not support energy harvesting operations concurrently with transmit/receive operations for wireless communication.

### SUMMARY

Some exemplary embodiments are related to an apparatus of a user equipment (UE), the apparatus having processing circuitry configured to decode, based on signals received from a network, a first configuration for wireless communications with the network, wherein the wireless communications and associated processes are performed by a wireless communications module of the UE and powered by energy generated by an energy harvesting module of the UE, decode, based on signals received from the network, a second configuration for a scheduling restriction for energy harvesting comprising a duration during which some or all of the wireless communications with the network are suspended, during the duration of the scheduling restriction, reduce a power state for the wireless communications module and initiate energy harvesting operations by the energy harvesting module and after the duration of the scheduling restriction, restore the power state for the wireless communications module and stop the energy harvesting operations by the energy harvesting module.

Other exemplary embodiments are related to an apparatus of a user equipment (UE), the apparatus having processing circuitry configured to decode, based on signals received from a network, a first configuration for wireless communications with the network, wherein the wireless communications and associated processes are performed by a wireless communications module of the UE and powered by energy generated by an energy harvesting module of the UE, determine one or more conditions are satisfied permitting uplink (UL) transmission skipping based on an energy level of the UE and drop one or more UL transmissions and reducing a power state for the wireless communications module.

Still further exemplary embodiments are related to an apparatus of a user equipment (UE), the apparatus having processing circuitry configured to decode, based on signals received from a network, a first configuration for wireless communications with the network, wherein the wireless communications and associated processes are performed by a wireless communications module of the UE and powered by energy generated by an energy harvesting module of the UE, configure transceiver circuitry to transmit assistance information to the network including recommended or desired configuration parameters for the wireless communications and decode, based on signals received from the network, a second configuration including a suspension or adjustment of some or all of the wireless communications in accordance with one or more of the recommended or desired configuration parameters.

### BRIEF DESCRIPTION OF THE DRAWINGS

FIG. 1 shows a network arrangement according to various exemplary embodiments.

FIG. 2 shows an exemplary UE according to various exemplary embodiments.

FIG. 3 shows an exemplary network base station according to various exemplary embodiments.

FIG. 4 shows an exemplary high-level architecture of a wireless communication device supporting energy harvesting according to various exemplary embodiments.

FIG. 5a shows a diagram for coexistence between energy harvest operations and wireless communication operations of a UE using a periodic scheduling restriction (energy harvesting gap) according to various exemplary embodiments.

FIG. 5b shows a diagram for coexistence between energy harvest operations and wireless communication operations of a UE using an aperiodic scheduling restriction (energy harvesting gap) according to various exemplary embodiments.

FIG. 6 shows a method for coexistence between energy harvest operations and wireless communication operations of a UE using a scheduling restriction (energy harvesting gap) according to various exemplary embodiments.

FIG. 7 shows a method for UL transmission skipping by a UE allowed only under certain conditions, e.g., only when the UE does not have enough energy harvested to perform the UL operations, according to various exemplary embodiments.

FIG. 8 shows a method for providing UE assistance information to the network for maintaining coexistence between energy harvest operations and wireless communication operations of the UE according to various exemplary embodiments.

### DETAILED DESCRIPTION

The exemplary aspects may be further understood with reference to the following description and the related appended drawings, wherein like elements are provided with the same reference numerals. The exemplary aspects describe operations for coexistence between energy harvest operations and radiofrequency (RF) communication operations of a UE. Some UEs, particularly low-power UEs, may be unable to simultaneously support energy harvest and RF operations on a wireless network. Additionally, even when these operations are simultaneously supported, the energy harvest may interfere with the RF frequencies used for wireless communication.

The exemplary aspects are described with regard to a UE. However, the use of a UE is provided for illustrative purposes. The exemplary aspects may be utilized with any electronic component that may establish a connection with a network and is configured with the hardware, software, and/or firmware to exchange information and data with the network and to perform energy harvesting operations. Therefore, the UE as described herein is used to represent any electronic component that is capable of transmit and receive (Tx/Rx) operations with one or more networks, e.g., the 5G radio access network (RAN), and is capable of energy harvesting.

The exemplary embodiments are also described with regard to a 5G New Radio (NR) radio access network (RAN).

However, reference to a 5G NR RAN is merely provided for illustrative purposes. The exemplary embodiments may be utilized with any network implementing functionalities similar to those described herein. Therefore, the 5G NR network as described herein may represent any type of network implementing similar functionalities as the 5G NR network.

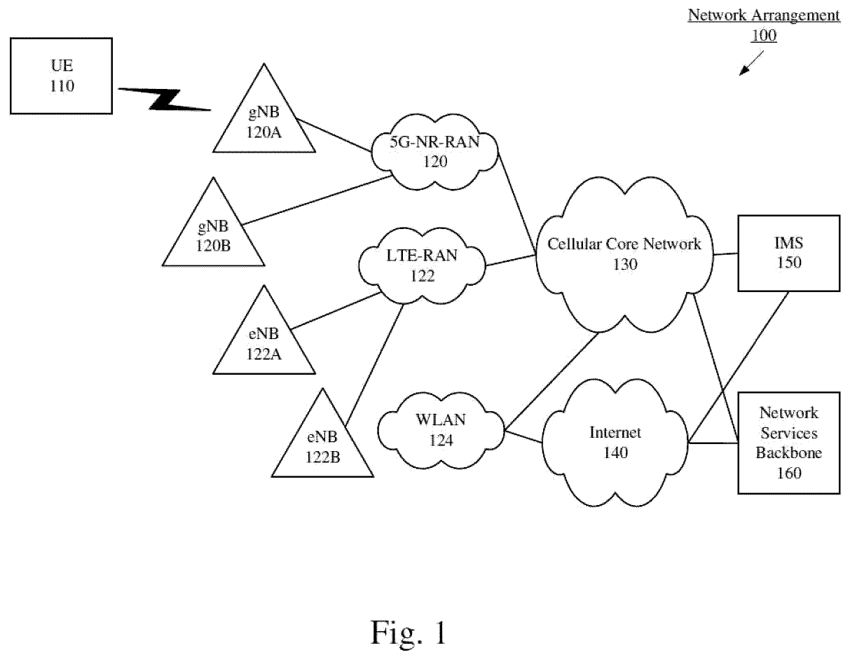

FIG. 1 shows an exemplary network arrangement 100 according to various exemplary embodiments. The exemplary network arrangement 100 includes a user equipment (UE) 110. Those skilled in the art will understand that the UE may be any type of electronic component that is configured to communicate via a network, e.g., mobile phones, tablet computers, smartphones, phablets, embedded devices, wearable devices, Cat-M devices, Cat-M1 devices, MTC devices, eMTC devices, other types of Internet of Things (IoT) devices, etc. It should also be understood that an actual network arrangement may include any number of UEs being used by any number of users. Thus, the example of a single UE 110 is merely provided for illustrative purposes.

The UE 110 may communicate directly with one or more networks. In the example of the network configuration 100, the networks with which the UE 110 may wirelessly communicate are a 5G NR radio access network (5G NR-RAN) 120, an LTE radio access network (LTE-RAN) 122 and a wireless local access network (WLAN) 124. Therefore, the UE 110 may include a 5G NR chipset to communicate with the 5G NR-RAN 120, an LTE chipset to communicate with the LTE-RAN 122 and an ISM chipset to communicate with the WLAN 124. However, the UE 110 may also communicate with other types of networks (e.g., legacy cellular networks) and the UE 110 may also communicate with networks over a wired connection. With regard to the exemplary aspects, the UE 110 may establish a connection with the 5G NR-RAN 120 and the LTE-RAN 122 in a NSA or DC mode of operation.

The 5G NR-RAN 120 and the LTE-RAN 122 may be portions of cellular networks that may be deployed by cellular providers (e.g., Verizon, AT&T, T-Mobile, etc.). These networks 120, 122 may include, for example, cells or base stations (Node Bs, eNodeBs, HeNBs, eNBS, gNBs, gNodeBs, macrocells, microcells, small cells, femtocells, etc.) that are configured to send and receive traffic from UEs that are equipped with the appropriate cellular chip set. The WLAN 124 may include any type of wireless local area network (WiFi, Hot Spot, IEEE 802.11x networks, etc.).

The UE 110 may connect to the 5G NR-RAN 120 via at least one of the next generation nodeB (gNB) 120A and/or the gNB 120B. Reference to two gNBs 120A, 120B is merely for illustrative purposes. The exemplary aspects may apply to any appropriate number of gNBs. The UE 110 may additionally connect to the LTE-RAN 122 via at least one of the enhanced nodeB (eNB) 122A and/or the eNB 122B. Reference to two eNBs 122A, 122B is merely for illustrative purposes. The exemplary aspects may apply to any appropriate number of eNBs.

In addition to the networks 120, 122 and 124 the network arrangement 100 also includes a cellular core network 130, the Internet 140, an IP Multimedia Subsystem (IMS) 150, and a network services backbone 160. The cellular core network 130, e.g., the 5GC for the 5G NR network, may be considered to be the interconnected set of components that manages the operation and traffic of the cellular network. The cellular core network 130 also manages the traffic that flows between the cellular network and the Internet 140.

The IMS 150 may be generally described as an architecture for delivering multimedia services to the UE 110 using the IP protocol. The IMS 150 may communicate with the cellular core network 130 and the Internet 140 to provide the multimedia services to the UE 110. The network services backbone 160 is in communication either directly or indirectly with the Internet 140 and the cellular core network 130. The network services backbone 160 may be generally described as a set of components (e.g., servers, network storage arrangements, etc.) that implement a suite of services that may be used to extend the functionalities of the UE 110 in communication with the various networks.

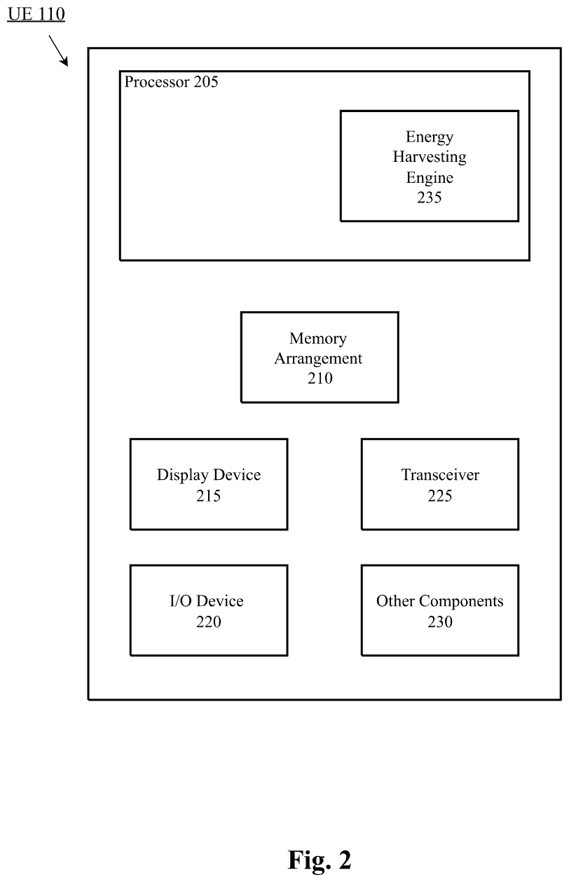

FIG. 2 shows an exemplary UE 110 according to various exemplary embodiments. The UE 110 will be described with regard to the network arrangement 100 of FIG. 1. The UE 110 may represent any electronic device and may include a processor 205, a memory arrangement 210, a display device 215, an input/output (I/O) device 220, a transceiver 225, and other components 230. The other components 230 may include, for example, an audio input device, an audio output device, a battery that provides a limited power supply, a data acquisition device, ports to electrically connect the UE 110 to other electronic devices, sensors to detect conditions of the UE 110, etc.

The processor 205 may be configured to execute a plurality of engines for the UE 110. For example, the engines may include an energy harvesting engine 235 for performing operations related to: determining energy harvesting needs for the UE; requesting the network for a scheduling restriction (or other scheduling-related operating parameters) for RF operations with the network, during which the UE can perform energy harvesting; and controlling/implementing operating parameters of the UE with respect to RF operations with the network and energy harvesting to optimize the performance of the UE. These and further operations will be described in greater detail below.

The above referenced engine being an application (e.g., a program) executed by the processor 205 is only exemplary. The functionality associated with the engines may also be represented as a separate incorporated component of the UE 110 or may be a modular component coupled to the UE 110, e.g., an integrated circuit with or without firmware. For example, the integrated circuit may include input circuitry to receive signals and processing circuitry to process the signals and other information. The engines may also be embodied as one application or separate applications. In addition, in some UEs, the functionality described for the processor 205 is split among two or more processors such as a baseband processor and an applications processor. The exemplary aspects may be implemented in any of these or other configurations of a UE.

The memory 210 may be a hardware component configured to store data related to operations performed by the UE 110. The display device 215 may be a hardware component configured to show data to a user while the I/O device 220 may be a hardware component that enables the user to enter inputs. The display device 215 and the I/O device 220 may be separate components or integrated together such as a touchscreen.

The transceiver 225 may be a hardware component configured to establish a connection with the 5G-NR RAN 120, the LTE RAN 122 etc. Accordingly, the transceiver 225 may operate on a variety of different frequencies or channels (e. g., set of consecutive frequencies). The transceiver 225 includes circuitry configured to transmit and/or receive signals (e.g., control signals, data signals). Such signals may be encoded with information implementing any one of the methods described herein. The processor 205 may be operably coupled to the transceiver 225 and configured to receive from and/or transmit signals to the transceiver 225. The processor 205 may be configured to encode and/or decode signals (e.g., signaling from a base station of a network) for implementing any one of the methods described herein.

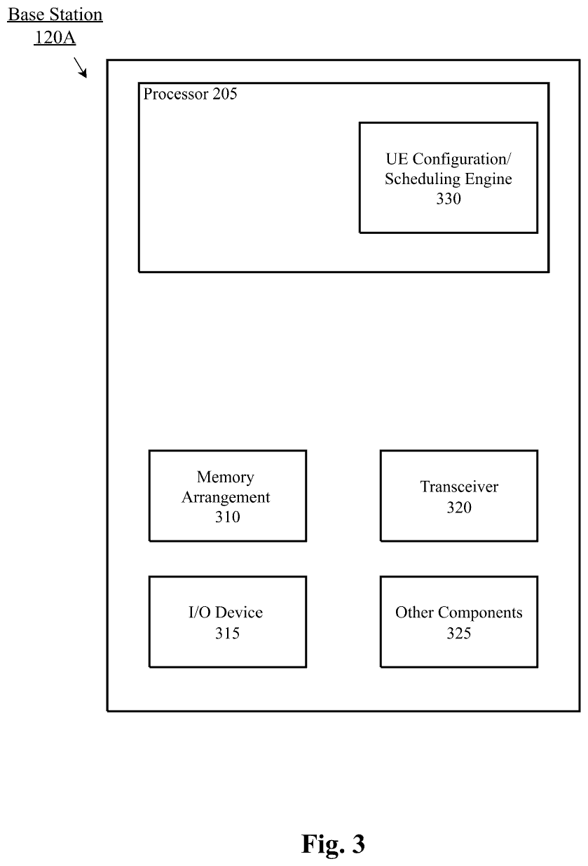

FIG. 3 shows an exemplary network base station, in this case gNB 120A, according to various exemplary embodiments. As noted above with regard to the UE 110, the gNB 120A may represent a serving cell for the UE 110. The gNB 120A may represent any access node of the 5G NR network through which the UE 110 may establish a connection and manage network operations. The gNB 120A illustrated in FIG. 3 may also represent the gNB 120B.

The gNB 120A may include a processor 305, a memory arrangement 310, an input/output (I/O) device 315, a transceiver 320, and other components 325. The other components 325 may include, for example, an audio input device, an audio output device, a battery, a data acquisition device, ports to electrically connect the gNB 120A to other electronic devices, etc.

The processor 305 may be configured to execute a plurality of engines of the gNB 120A. For example, the engines may include a UE configuration/scheduling engine 330 for performing operations including receiving a UE request for a scheduling restriction (or other scheduling-related operating parameters) for RF operations with the network; and configuring/scheduling the UE with operating parameters that allow the UE to optimize its performance with respect to RF operations with the network and energy harvesting. These and further operations will be described in greater detail below.

The above noted engine 330 being an application (e.g., a program) executed by the processor 305 is only exemplary. The functionality associated with the engine 330 may also be represented as a separate incorporated component of the base station 300 or may be a modular component coupled to the base station 300, e.g., an integrated circuit with or without firmware. For example, the integrated circuit may include input circuitry to receive signals and processing circuitry to process the signals and other information. In addition, in some base stations, the functionality described for the processor 305 is split among a plurality of processors (e.g., a baseband processor, an applications processor, etc.). The exemplary embodiments may be implemented in any of these or other configurations of a base station.

The memory 310 may be a hardware component configured to store data related to operations performed by the UEs 110, 112. The I/O device 315 may be a hardware component or ports that enable a user to interact with the gNB 120A.

The transceiver 320 may be a hardware component configured to exchange data with the UE 110 and any other UE in the system 100. The transceiver 320 may operate on a variety of different frequencies or channels (e.g., set of consecutive frequencies). Therefore, the transceiver 320 may include one or more components (e.g., radios) to enable the data exchange with the various networks and UEs. The transceiver 320 includes circuitry configured to transmit and/or receive signals (e.g., control signals, data signals). Such signals may be encoded with information implementing any one of the methods described herein. The processor 305 may be operably coupled to the transceiver 320 and configured to receive from and/or transmit signals to the transceiver 320. The processor 305 may be configured to encode and/or decode signals (e.g., signaling from a UE) for implementing any one of the methods described herein.

A passive device can refer to a low-power device that does not require an external (electrical) power source to operate over its intended lifetime. Passive Internet of Things (IOT) devices can provide an alternative to other passive technologies including, e.g., radiofrequency identification (RFID). Relative to existing 3GPP technologies, including Low Power Wide Area (LPWA) technologies such as narrowband IoT (NB-IoT) and enhanced machine-type communication (eMTC), the passive IoT device is intended to have a complexity and power consumption that is orders of magnitude lower than existing 3GPP technologies. For example, the UE power consumption can be on the order of 1-100 microWatts (uW). The UE may operate either without a battery or with an internal energy storage that does not need to be replaced or recharged manually.

The passive IoT device may rely on energy harvesting to power the device, wherein energy can be generated from external sources such as an external RF field, light, heat, vibration, or other sources. Energy harvesting has been utilized by other technologies such as NFC (Near Field Communication). Wireless communication with energy harvesting is an environmentally friendly technology that removes or relaxes the reliance on a battery and benefits the life cycle of device. By using energy harvesting, the device can operate for a long time (e.g., its entire lifespan) without needing external intervention or maintenance, e.g., without replacing or recharging a battery. However, in view of the need for low power consumption, the device may be constrained in terms of processing power, communication range, etc. Additionally, if the energy harvesting technology uses an external RF field as a source, the frequencies that can provide energy harvesting may be different from those required for communication. Thus, the device may not support energy harvesting operations concurrently with transmit/receive operations for wireless communication. Additionally, even when these operations are simultaneously supported from a hardware perspective, the energy harvest may interfere with the RF frequencies used for wireless communication.

According to various exemplary embodiments described herein, operations are described for coexistence between energy harvest operations and wireless communication operations of a UE. In some aspects, an energy harvesting gap (e.g., scheduling restriction) can be configured for the UE. In other aspects, the UE may be allowed to skip one or more scheduled UL channel/signal transmissions under certain conditions, e.g., when the UE does not have sufficient energy harvested to perform the UL transmissions. In still other aspects, enhancements to UE assistance information are described to support energy harvesting and/or power saving at the UE.

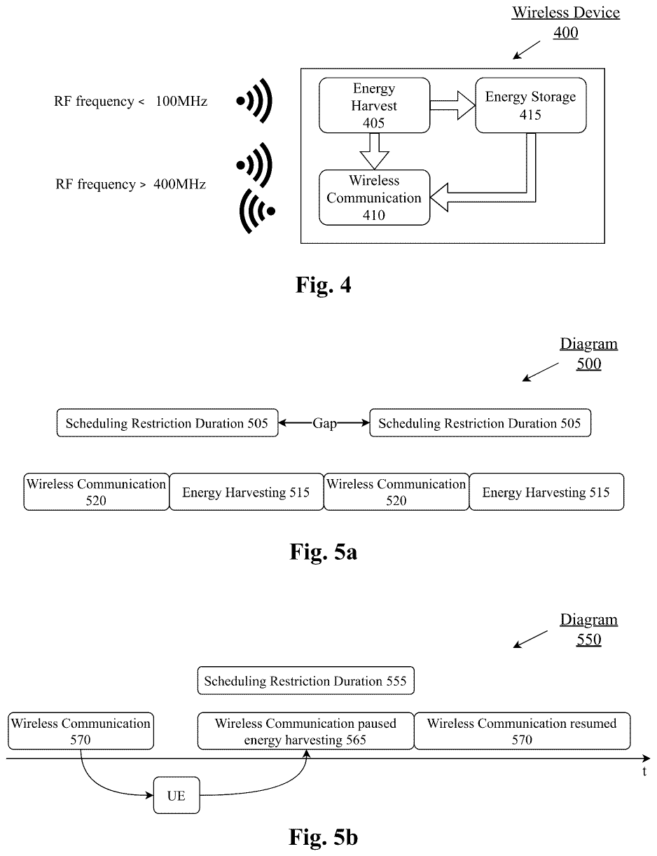

FIG. 4 shows an exemplary high-level architecture of a wireless communication device 400 supporting energy harvesting according to various exemplary embodiments. The device 400 may correspond to the UE 110 described above in FIGS. 1-2. The device 400 includes a first module 405 for energy harvesting using an external RF source and a second module 410 for wireless communications. The module 405 for energy harvesting can use low frequencies, e.g., under 100 MHz, so that the wavelength is large enough to have a near field effect. The module 410 for wireless communications can use higher frequencies, e.g., over 400 MHz, so that the wavelength is small enough to communicate with a far field. The module 410 for wireless communications can be powered from the energy harvested by the first module 405. In this example, the device 400 also includes an energy storage 415, e.g., battery, that can be charged by the harvested energy. However, in other embodiments described herein and in other types of devices, the battery may be optional and the energy harvest module may temporarily store and directly provide power to the module 410 for wireless communications. Additionally, it should be understood that the modules 405 and 410, despite being described separately, may share some components, e.g., an antenna.

In some embodiments, the network node with which the UE is in wireless communication (or another network node in communication with the network node) may also provide the external RF field for energy harvesting. Additionally, in other embodiments, the module 405 for energy harvesting may use energy sources other than an external RF field, e.g., light, heat, vibration, etc.

In one aspect of these exemplary embodiments, for coexistence between energy harvest operations and wireless communication operations of a UE, an energy harvesting gap (e.g., scheduling restriction) can be configured for the UE. During the energy harvesting gap the UE will not expect any wireless communications and can suspend these operations. With the RF module for wireless communications fully or partially powered down, the UE can activate an energy harvesting module to harvest energy from an external RF field and/or other sources such as light, heat or vibration. In some embodiments, an energy storage module can be charged to power the module for wireless communications when an external energy source is not available. When the energy harvesting gap ends the energy harvesting module can suspend its operations. The RF operations for wireless communication can be fully resumed and the harvested energy can directly power the communications.

In one embodiment, the scheduling restriction may be configured to apply to all RF communications configured for the UE, including, e.g., both uplink (UL) transmission (Tx) and downlink (DL) reception (Rx); all frequency bands and all component carriers (CC) during carrier aggregation (CA) operation; and/or both the master cell group (MCG) and the secondary cell group (SCG) during dual connectivity (DC) operation.

In other embodiments, only Tx on the UL can be restricted or only Rx on the DL can be restricted. In still other embodiments, a subset of CCs or frequency bands can be restricted in CA operation. In still other embodiments, only the MCG or only the SCG can be restricted in DC operation.

During the period of the scheduling restriction, the network may not schedule resources for the UE for the restricted transmission(s)/reception(s) and the UE does not expect to transmit/receive these restricted frequencies.

If the scheduling restriction configured for the UE is periodic, the configuration parameters may include a length, a starting slot (e.g., offset), and a repetition period. When the scheduling restriction is aperiodic, the configuration parameters may include a length and a starting slot (e.g., offset) for a one-shot scheduling restriction. In some embodiments, the periodic or aperiodic scheduling restriction can also include a timing advance.

FIG. 5a shows a diagram 500 for coexistence between energy harvest operations and wireless communication operations of a UE using a periodic scheduling restriction (energy harvesting gap) according to various exemplary embodiments. In this example, a periodic scheduling restriction is configured to have a duration 505 and a gap 510 between adjacent durations 505 that can be configured by the network according to a periodicity or duty cycle. During the duration 505 of the scheduling restriction, the UE can power down its wireless communications module, in whole or in part. For example, the UE does not expect to be scheduled for any UL transmissions or DL receptions during the duration 505. At the times when the RF module is powered down (fully or partially), the UE can perform energy harvesting 515. When the duration 505 has lapsed, the wireless communications 520 can resume. Thus, the energy harvesting and RF operations will not interfere with one another. A UE with, e.g., low energy storage, can conserve energy while simultaneously recharging during the energy harvesting gaps.

In another aspect of these exemplary embodiments, the UE can request the network to configure the periodic or aperiodic scheduling restriction. For the periodic scheduling restriction, the UE can request recommended (or desired) parameters including, e.g., a duration of the scheduling restriction; a duty cycle of the scheduling restriction, e.g., the gap between adjacent scheduling restrictions; whether the scheduling restriction should apply to only DL, only UL, or both DL and UL; and/or CCs or frequency bands to which the scheduling restriction should apply. In some embodiments, when the network node with which the UE is in wireless communication (or another network node in communication with the network node) provides the external RF field for energy harvesting, the UE can also request a recommended (or desired) frequency to use for energy harvest and/or a network Tx power to use for transmitting these frequencies.

The request can be transmitted via, e.g., radio resource control (RRC) signaling (UEAssistanceInformation), medium access control (MAC) control element (MAC-CE), or uplink control information (UCI). In some embodiments, a request for certain parameters may be transmitted via one option for transmission, e.g., RRC, while a request for other parameters may be transmitted via another option for transmission, e. g., MAC-CE or UCI, to be described in greater detail below.

For the aperiodic scheduling restriction, the UE can include similar parameters in the request, e.g., a duration; only DL, only UL, or both DL and UL; CCs or frequency bands; frequencies and/or network Tx power to use for transmitting energy harvesting frequencies. Similar to above, the request can be transmitted via, e.g., RRC, MAC-CE or UCI.

The aperiodic request from the UE may be allowed only when certain conditions are met. In one example, when the harvested energy is not sufficient to sustain wireless communication, the UE may send the aperiodic request. In another example, a prohibit timer can be introduced to avoid frequent aperiodic UE requests. The prohibit timer can be started after the aperiodic request is sent, and the UE is barred from sending any additional requests until the expiry of the timer.

FIG. 5b shows a diagram 550 for coexistence between energy harvest operations and wireless communication operations of a UE using an aperiodic scheduling restriction (energy harvesting gap) according to various exemplary embodiments. In this example, an aperiodic scheduling restriction is configured to have a duration 555. The UE can request the aperiodic scheduling restriction when wireless communications 570 are operational but not sustainable based on the currently harvested energy. During the duration 555 of the scheduling restriction, the UE can power down its wireless communications module, in whole or in part. For example, the UE does not expect to be scheduled for any UL transmissions or DL receptions during the duration 555. At the times when the RF module is powered down (fully or partially) , the UE can perform energy harvesting 565. When the duration 555 has lapsed, the wireless communications 570 can resume.

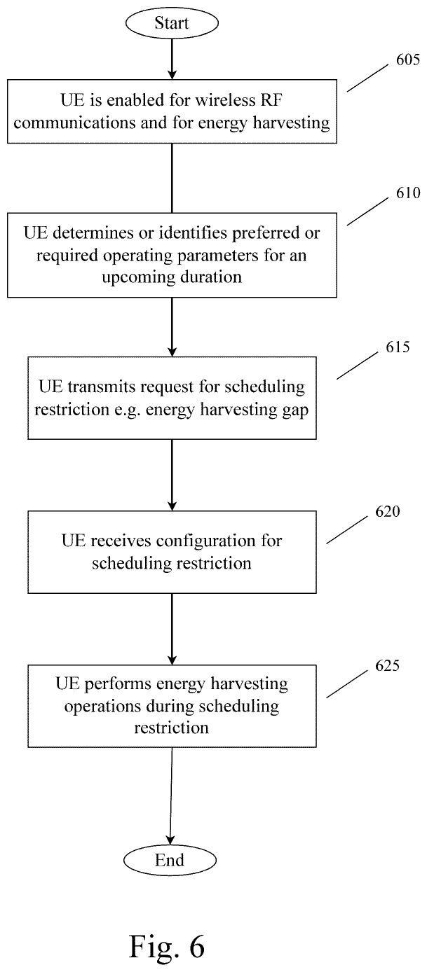

FIG. 6 shows a method 600 for coexistence between energy harvest operations and wireless communication operations of a UE using a scheduling restriction (energy harvesting gap) according to various exemplary embodiments.

In 605, the UE is enabled for wireless RF communications and for energy harvesting. In some scenarios, the UE may be a passive IoT device designed to consume very little power and/or to operate without a battery (or with a battery that is not intended to be replaced or recharged manually). The UE can be enabled for energy harvesting from sources such as an external RF field, light, heat, vibration, or other external sources. Some UEs may be unable to simultaneously perform energy harvesting operations and RF operations due to, e.g., limited processing capabilities and/or interference between the operations.

In some embodiments, the network may determine to configure a scheduling restriction for the UE without first receiving a UE request and the method proceeds to 620. Otherwise, the method proceeds to 610.

In 610, the UE determines or identifies preferred or required operating parameters for an upcoming duration. For example, the UE can determine it should limit its RF operations, perform power saving operations, and/or perform energy harvesting operations. Depending on the type and specifications of the UE, the preferred operating parameters may vary. For example, the UE may be limited in processing power and low in energy (stored and/or recently harvested energy) and determine that RF operations should be reduced or ended and power harvesting operations should be initiated. In another example, the UE may be low in energy and incapable of performing energy harvesting without powering down its RF module for wireless communications. In still another example, prior to transmitting an aperiodic request, the UE may determine that some pre-configured conditions are met and the aperiodic request is allowed for the UE, e.g., wireless communications cannot be sustained.

In 615, the UE transmits a request to the network for a configuration of a scheduling restriction for energy harvesting, e. g., an energy harvesting gap. In this example, the request may be for a periodic scheduling restriction or an aperiodic scheduling restriction. The request may be transmitted in different ways depending on the contents of the request, e. g., via RRC in UE assistance information, via MAC-CE, or via UCI. As described above, the contents of the request can include recommended or desired parameters including a duration, duty cycle, DL/UL or both, CCs or frequency bands, frequency and Tx power for network transmissions for energy harvesting, etc.

If the request is for an aperiodic scheduling restriction, the UE can start a prohibit timer. If the network does not honor the request and provide a configuration for an aperiodic scheduling restriction within the timer duration, the UE can retransmit the request after the expiry of the prohibit timer.

In 620, the UE receives a configuration for a scheduling restriction for energy harvesting. As described above, when the scheduling restriction is periodic, the configuration parameters may include a length, a starting slot (e.g., offset), a repetition period and a timing advance. When the scheduling restriction is aperiodic, the configuration parameters may include a length, a starting slot (e.g., offset), and a timing advance. The scheduling restriction may be configured for a subset of CCs or frequency bands during CA operation, and may be configured for the MCG, the SCG, or both the MCG and SCG during DC operation.

In 625, the UE performs energy harvesting operations during the scheduling restriction. The RF module (for wireless communication) of the UE may be in a reduced power state or powered off. After the duration, the UE can resume RF operations for wireless communication.

According to another aspect of these exemplary embodiments, for coexistence between energy harvest operations and wireless communication operations of a UE, the UE may be allowed to skip one or more scheduled UL channels/signals. The UL skipping may be allowed only under certain conditions, e.g., only when the UE does not have enough energy harvested to perform the UL operations. In some scenarios, during the skipped UL resources, the UE may be allowed to enter a lower power state and/or perform energy harvesting. In some embodiments, the UE can indicate the upcoming UL skipping to the network using a special payload.

In current NR specification, UL skipping is allowed on PUSCH only under the condition that UE has no UL data. In the present embodiments, UL skipping can be allowed under other conditions related to energy harvesting needs of the UE, e. g., the UE has insufficient energy to transmit the upcoming scheduled UL transmission or multiple UL transmissions.

When the required power for transmitting scheduled UL transmissions is not currently met by the UE, the UE can evaluate which ones of the scheduled UL transmissions (if any) can be transmitted with the power remaining to the UE. The UL skipping can be performed according to a priority order wherein certain UL channels/signals are dropped prior to other UL channels/signals. The priority order can be determined based on, e.g., a size of the UL transmission, an importance of the UL transmission, etc., relative to the other UL transmissions.

In one illustrative embodiment, the priority order for UL skipping can comprise the following UL channels/signals, listed from first to be dropped to last to be dropped: dynamic grant (DG) PUSCH; configured grant (CG) PUSCH; periodic/semi-persistent sounding reference signal (SRS); aperiodic SRS; PUCCH carrying CSI; PUCCH carrying scheduling requests (SR); and PUCCH carrying HARQ-ACK feedback. In this example, the PUCCH carrying HARQ-ACK is dropped last (selected to have the highest priority) because HARQ-ACK supports DL reception and because the payload of HARQ-ACK is very small.

In some embodiments, a special payload can be transmitted from the UE to indicate that the UE skips an upcoming UL transmission because of lack of energy. The special payload requires a very small amount of energy from the UE for transmission, e.g., the payload size is minimal. For example, UCI (e.g., PUCCH format 0/2) can be used to transmit the UL skipping indication to the network. The special payload may be transmitted only during the first N occurrences of the UL skipping due to lack of energy. After the N occurrences of the special UL skipping, the UE can stop transmitting the special payload even when subsequent UL channels/signals are skipped.

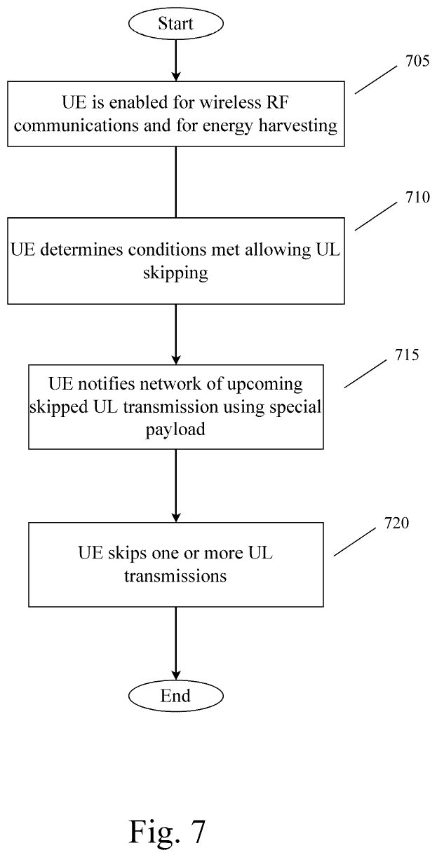

FIG. 7 shows a method 700 for UL transmission skipping by a UE allowed only under certain conditions, e.g., only when the UE does not have enough energy harvested to perform the UL operations, according to various exemplary embodiments.

In 705, the UE is enabled for wireless RF communications and for energy harvesting, similar to step 605 of FIG. 6.

In 710, the UE determines one or more conditions are met allowing UL skipping. The conditions may relate to a current energy level of the UE or anticipated upcoming energy usage for scheduled UL transmissions. For example, the UE can determine it does not have sufficient power to transmit one or more upcoming UL transmissions. The UE can evaluate which ones of the scheduled UL transmissions (if any) can be transmitted with the power remaining to the UE. The UL skipping can be performed according to a priority order wherein certain UL channels/signals are dropped prior to other UL channels/signals.

In 715, the UE notifies the network of the upcoming skipped UL transmission using a special payload. The special payload requires a very small amount of energy from the UE for transmission. The special payload may be transmitted only during the first N occurrences of the UL skipping due to lack of energy, after which the UE stops transmitting the special payload even when subsequent UL channels/signals are skipped.

In 720, the UE skips the one or more UL transmissions. In some scenarios, during the skipped UL resources, the UE may be allowed to enter a lower power state and/or perform energy harvesting. The RF module (for wireless communication) of the UE may be in a reduced power state or powered off.

If the UE energy remains low, the UE may continue skipping UL transmissions until the UE has harvested enough energy to resume the UL transmissions.

According to another aspect of these exemplary embodiment, enhancements to UE assistance information are described to support energy harvesting and/or power saving at the UE.

In current NR, the UE is allowed to send UE assistance information (UAI) to the network to request or recommend certain network configurations, or to inform the network of certain condition observed at the UE. UAI is reported via RRC in UEAssistanceInformation and can include parameters such as: a delay budget report; overheating assistance, including a reduced # of CCs, a reduced maximum BW, reduced DL MIMO layers, reduced UL MIMO layers, etc. ; a DRX preference; and other parameters.

In one embodiment, for wireless communication with energy harvesting, the UE can additionally report to the network a preferred duty cycle, e.g., the percentage of time that the network can schedule the UE. The preferred duty cycle can apply to UL only or both DL and UL. This requested parameter for duty cycle can be similar to that described above for the periodic energy harvesting gap. However, in these embodiments, the UE does not necessarily receive a scheduling restriction in response. The network can use the requested duty cycle in different ways to inform its scheduling of the UE.

In one embodiment, the duty cycle can be reported similarly as power headroom (PHR), e.g., in MAC-CE or UCI. The MAC-CE or UCI can be periodically configured by the network or aperiodically triggered by the network or the UE when certain conditions are met. Alternatively, the duty cycle can be reported via RRC in UE assistance information.

In another embodiment, the UE can additionally send a request to the NW for a dormancy operation, especially when stored energy is not enough to sustain reliable communication. The request can include, e. g., a request to stop a subset of component carriers in CA operation or a request to suspend all the component carriers in the CA operation. The request can also include a time duration, i.e., UE only request the network to suspend the communication for a reported duration of time. This embodiment may be similar to the aperiodic scheduling restriction discussed above for the energy harvesting gap.

In still another embodiment, the UE can request a coverage extension or power saving solution to be configured by the network. This request can be used when, e.g., the UE has limited power available which limits the coverage for the UE.

The UE can request parameters relating to one or multiple of: the slot aggregation level on PDSCH; the repetition of PDCCH; the slot aggregation level of PUCCH/PUSCH; the recommended CDRX configuration; the recommended PDCCH search space configuration especially the duty cycle; disable DL HARQ-ACK feedback; the maximum modulation and coding scheme (MCS) on DL and UL; the maximum number of HARQ processes; the minimum processing timeline including k0, k1, k2, where k0 is from DCI to scheduled PDSCH; k1 is from PDSCH to HARQ-ACK; and k2 is from DCI to scheduled PUSCH.

For any of the types of UE assistance information or parameter requests discussed above, the information/parameters can be provided in RRC, MAC-CE, or UCI. For example, some low complexity devices may not support L3 (RRC), or the overhead caused by L3 reporting may consume too much energy to reasonably support communications on these devices. Thus, a MAC-CE or UCI requiring less energy/overhead can be used. In some embodiments, the method for transmitting the UE assistance information can depend on changing RF or UE conditions.

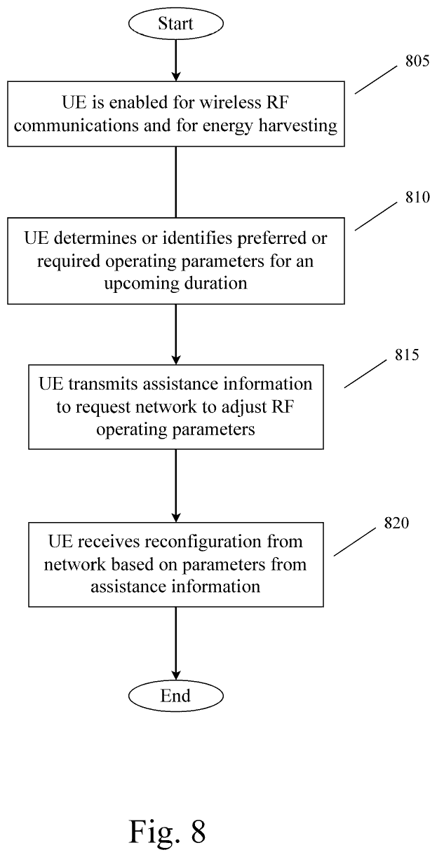

FIG. 8 shows a method 800 for providing UE assistance information to the network for maintaining coexistence between energy harvest operations and wireless communication operations of the UE according to various exemplary embodiments.

In 805, the UE is enabled for wireless RF communications and for energy harvesting, similar to step 605 of FIG. 6.

In 810, the UE determines or identifies preferred or required operating parameters for an upcoming duration, similar to step 610 of FIG. 6. For example, the UE can determine it should limit its RF operations, perform power saving operations, and/or perform energy harvesting operations.

In 815, the UE transmits UE assistance information and/or request parameters to the network for the network to adjust RF operating parameters of the UE. For example, as described above, the UE assistance information can comprise a preferred duty cycle, a request for some or all component carriers to be suspended, or preferred parameters related to coverage or power savings. The UE assistance information can be included in UL RRC signaling, a MAC-CE or UCI.

In 820, the UE receives a reconfiguration from the network based on the parameters reported/requested in the UE assistance information. For example, some RF operations may be disabled or modified. In some embodiments, based on the reconfiguration parameters, the UE is able to perform energy harvesting, conserve power, and/or improve its coverage.

### EXAMPLES

In a first example, a method performed by a user equipment (UE), comprising receiving a first configuration from a network for wireless communications with the network, wherein the wireless communications and associated processes are performed by a wireless communications module of the UE and powered by energy generated by an energy harvesting module of the UE, receiving a second configuration from the network for a scheduling restriction for energy harvesting comprising a duration during which some or all of the wireless communications with the network are suspended, during the duration of the scheduling restriction, reducing a power state for the wireless communications module and initiating energy harvesting operations by the energy harvesting module and after the duration of the scheduling restriction, restoring the power state for the wireless communications module and stopping the energy harvesting operations by the energy harvesting module.

In a second example, the method of the first example, wherein the second configuration indicates the scheduling restriction is applied to all uplink (UL) transmissions, all downlink (DL) receptions, or both the UL transmissions and DL receptions.

In a third example, the method of the first example, wherein the second configuration indicates the scheduling restriction is applied to a subset of component carriers or a subset of frequency bands in a carrier aggregation (CA) operation or dual connectivity (DC) operation.

In a fourth example, the method of the first example, wherein the second configuration indicates the scheduling restriction is applied to a master cell group (MCG), a secondary cell group (SCG), or both the MCG and SCG in a dual connectivity (DC) operation.

In a fifth example, the method of the first example, wherein the second configuration indicates the scheduling restriction is periodic and includes parameters for the duration, an offset, and a periodicity for the scheduling restriction.

In a sixth example, the method of the first example, wherein the second configuration indicates the scheduling restriction is aperiodic and includes parameters for the duration and an offset for the scheduling restriction.

In a seventh example, the method of the first example, further comprising transmitting a request for the scheduling restriction, the request including recommended or desired configuration parameters for the scheduling restriction.

In an eighth example, the method of the seventh example, wherein the recommended or desired configuration parameters for the scheduling restriction include the duration, a duty cycle or a transmission direction of uplink (UL), downlink (DL), or UL and DL.

In a ninth example, the method of the seventh example, wherein the recommended or desired configuration parameters for the scheduling restriction include a subset of component carriers or a subset of frequency bands in a carrier aggregation (CA) operation or dual connectivity (DC) operation.

In a tenth example, the method of the seventh example, wherein the recommended or desired configuration parameters for the scheduling restriction include: a frequency used for the energy harvesting via a near field effect of the frequency; or a network transmit power to use to transmit the frequency.

In an eleventh example, the method of the seventh example, wherein the request is transmitted only when the energy harvesting is insufficient to sustain wireless communication.

In a twelfth example, the method of the seventh example, wherein the request is associated with a prohibit timer duration during which the UE is restricted from retransmitting the request or transmitting a new request.

In a thirteenth example, a processor configured to perform any of the methods of the first through twelfth examples.

In a fourteenth example, a user equipment (UE) comprising a transceiver configured to communicate with a network and a processor communicatively coupled to the transceiver and configured to perform any of the methods of the first through twelfth examples.

In a fifteenth example, a method performed by a user equipment (UE), comprising receiving a first configuration from a network for wireless communications with the network, wherein the wireless communications and associated processes are performed by a wireless communications module of the UE and powered by energy generated by an energy harvesting module of the UE, determining one or more conditions are satisfied permitting uplink (UL) transmission skipping based on an energy level of the UE and dropping one or more UL transmissions and reducing a power state for the wireless communications module.

In a sixteenth example, the method of the fifteenth example, wherein the one or more conditions comprise the energy level being too low to transmit the one or more UL transmissions.

In a seventeenth example, the method of the fifteenth example, wherein the UL transmission skipping is applied to one or multiple types of channels or signals.

In an eighteenth example, the method of the seventeenth example, wherein the types of channels or signals are provided in a priority order wherein lower priority channels or signals are dropped before higher priority channels of signals.

In a nineteenth example, the method of the eighteenth example, wherein physical uplink shared channel (PUSCH) transmissions are a lower priority channel or signal relative to physical uplink control channel (PUCCH) transmissions.

In a twentieth example, the method of the nineteenth example, wherein PUCCH carrying HARQ-ACK is a highest priority channel or signal.

In a twenty first example, the method of the fifteenth example, further comprising, prior to dropping the one or more UL transmissions, transmitting a special payload indicating to the network the UL transmissions are to be skipped based on the energy level.

In a twenty second example, the method of the twenty first example, wherein a payload size for the special payload is small relative to payload sizes for the one or more UL transmissions to be dropped.

In a twenty third example, the method of the twenty first example, wherein the special payload comprises physical uplink control channel (PUCCH) format 0_2.

In a twenty fourth example, the method of the twenty first example, wherein the special payload is retransmitted a maximum number of times and the UE stops retransmitting the special payload.

In a twenty fifth example, a processor configured to perform any of the methods of the fifteenth through twenty fourth examples.

In a twenty sixth example, a user equipment (UE) comprising a transceiver configured to communicate with a network and a processor communicatively coupled to the transceiver and configured to perform any of the methods of the fifteenth through twenty fourth examples.

In a twenty seventh example, a method performed by a user equipment (UE), comprising receiving a first configuration from a network for wireless communications with the network, wherein the wireless communications and associated processes are performed by a wireless communications module of the UE and powered by energy generated by an energy harvesting module of the UE, transmitting assistance information to the network including recommended or desired configuration parameters for the wireless communications and receiving a second configuration from the network including a suspension or adjustment of some or all of the wireless communications in accordance with one or more of the recommended or desired configuration parameters.

In a twenty eighth example, the method of the twenty seventh example, wherein the recommended or desired configuration parameters include a duty cycle for UE scheduling.

In a twenty ninth example, the method of the twenty eighth example, wherein the duty cycle is indicated for only uplink (UL) scheduling or both UL and downlink (DL) scheduling.

In a thirtieth example, the method of the twenty eighth example, wherein the assistance information is transmitted in a medium access control (MAC) control element (MAC-CE) or uplink control information (UCI).

In a thirty first example, the method of the thirtieth example, wherein the MAC-CE or UCI indicating the duty cycle is reported in a periodic resource, an aperiodic resource triggered by the network, or an aperiodic resource triggered by the UE when a trigger condition is met.

In a thirty second example, the method of the twenty eighth example, wherein the assistance information is transmitted in radio resource control (RRC) signaling.

In a thirty third example, the method of the twenty seventh example, wherein the recommended or desired configuration parameters include a request to suspend some or all of configured component carriers (CC) in carrier aggregation (CA) operation or dual connectivity (DC) operation.

In a thirty fourth example, the method of the twenty seventh example, wherein the recommended or desired configuration parameters include a duration.

In a thirty fifth example, the method of the twenty seventh example, wherein the recommended or desired configuration parameters include parameters for extending a coverage of the UE or achieving power savings.

In a thirty sixth example, the method of the thirty fifth example, wherein the parameters for extending a coverage of the UE or achieving power savings include a slot aggregation level on physical downlink shared channel (PDSCH); a repetition of physical downlink control channel (PDCCH); a slot aggregation level of PUCCH physical uplink control channel (PUCCH) or physical uplink shared channel (PUSCH); a recommended discontinuous reception configuration; a recommended PDCCH search space configuration; disable DL HARQ-ACK feedback; a maximum modulation and coding scheme (MCS) on DL and UL; and a maximum number of HARQ processes; a minimum processing timeline including k0, k1, k2.

In a thirty seventh example, the method of the twenty seventh example, wherein the assistance information is transmitted in radio resource control (RRC) signaling, a medium access control (MAC) control element (MAC-CE), or uplink control information (UCI), wherein multiple ones of the RRC signaling, the MAC-CE and the UCI are available for transmitting the assistance information and one of the RRC signaling, the MAC-CE or the UCI is selected based on current or changing radiofrequency conditions or UE conditions.

In a thirty eighth example, a processor configured to perform any of the methods of the twenty seventh through thirty seventh examples.

In a thirty ninth example, a user equipment (UE) comprising a transceiver configured to communicate with a network and a processor communicatively coupled to the transceiver and configured to perform any of the methods of the twenty seventh through thirty seventh examples.

Those skilled in the art will understand that the above-described exemplary aspects may be implemented in any suitable software or hardware configuration or combination thereof. An exemplary hardware platform for implementing the exemplary aspects may include, for example, an Intel x86 based platform with compatible operating system, a Windows OS, a Mac platform and MAC OS, a mobile device having an operating system such as iOS, Android, etc. In a further example, the exemplary aspects of the above described method may be embodied as a program containing lines of code stored on a non-transitory computer readable storage medium that, when compiled, may be executed on a processor or microprocessor.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although this application described various aspects each having different features in various combinations, those skilled in the art will understand that any of the features of one aspect may be combined with the features of the other aspects in any manner not specifically disclaimed or which is not functionally or logically inconsistent with the operation of the device or the stated functions of the disclosed aspects.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalent.

1. An apparatus of a user equipment (UE), the apparatus comprising processing circuitry configured to:
decode, based on signals signaling received from a network, a first configuration for wireless communications with the network, wherein the wireless communications and associated processes are performed by a wireless communications module of the UE and powered by energy generated by an energy harvesting module of the UE;
decode, based on signals signaling received from the network, a second configuration for a scheduling restriction for energy harvesting operations comprising a duration during which some or all of the wireless communications with the network are suspended;
during the duration of the scheduling restriction, reduce a power state for the wireless communications module and initiate energy harvesting operations by the energy harvesting module; and
after the duration of the scheduling restriction, restore the power state for the wireless communications module and stop the energy harvesting operations by the energy harvesting module.

2. The apparatus of claim 1, wherein the second configuration indicates the scheduling restriction is applied to all uplink (UL) transmissions, all downlink (DL) receptions, or both the UL transmissions and DL receptions.

3. The apparatus of claim 1, wherein the second configuration indicates the scheduling restriction is applied to a subset of component carriers or a subset of frequency bands in a carrier aggregation (CA) operation or dual connectivity (DC) operation.

4. The apparatus of claim 1, wherein the second configuration indicates the scheduling restriction is applied to a master cell group (MCG), a secondary cell group (SCG), or both the MCG and SCG in a dual connectivity (DC) operation.

5. The apparatus of claim 1, wherein the second configuration indicates the scheduling restriction is periodic and includes parameters for the duration, an offset, and a periodicity for the scheduling restriction.

6. The apparatus of claim 1, wherein the second configuration indicates the scheduling restriction is aperiodic and includes parameters for the duration and an offset for the scheduling restriction.

7. The apparatus of claim 1, wherein the processing circuitry is further configured to:
configure transceiver circuitry to transmit generate, for transmission to the network, a request for the scheduling restriction, the request including recommended or desired configuration parameters for the scheduling restriction.

8. The apparatus of claim 7, wherein the recommended or desired configuration parameters for the scheduling restriction include the duration, a duty cycle or a transmission direction of uplink (UL), downlink (DL), or UL and DL.

9. The apparatus of claim 7, wherein the recommended or desired configuration parameters for the scheduling restriction include a subset of component carriers or a subset of frequency bands in a carrier aggregation (CA) operation or dual connectivity (DC) operation.

10. The apparatus of claim 7, wherein the recommended or desired configuration parameters for the scheduling restriction include: a frequency used for the energy harvesting operations via a near field effect of the frequency; or a network transmit power to use to transmit the frequency.

11. The apparatus of claim 7, wherein the request is transmitted only when energy harvesting is insufficient to sustain wireless communication.

12. The apparatus of claim 7, wherein the request is associated with a prohibit timer duration during which the UE is restricted from retransmitting the request or transmitting a new request.

13. An apparatus of a user equipment (UE), the apparatus comprising processing circuitry configured to:
decode, based on signals signaling received from a network, a first configuration for wireless communications with the network, wherein the wireless communications and associated processes are performed by a wireless communications module of the UE and powered by energy generated by an energy harvesting module of the UE;
determine one or more conditions are satisfied permitting uplink (UL) transmission skipping based on an energy level of the UE; and
drop one or more UL transmissions and reducing a power state for the wireless communications module.

14. The apparatus of claim 13, wherein the one or more conditions comprise the energy level being insufficient too low to transmit the one or more UL transmissions.

15. The apparatus of claim 13, wherein the UL transmission skipping is applied to one or multiple types of channels or signals.

16. The apparatus of claim 15, wherein the one or more types of channels or signals are provided in a priority order wherein lower priority channels or signals are dropped before higher priority channels of signals.

17. The apparatus of claim 16, wherein physical uplink shared channel (PUSCH) transmissions are a lower priority channel or signal relative to physical uplink control channel (PUCCH) transmissions.

18. The apparatus of claim 17, wherein PUCCH carrying HARQ-ACK is a highest priority channel or signal.

19. The apparatus of claim 13, wherein the processing circuity is further configured to:
prior to dropping the one or more UL transmissions, configure transceiver circuitry to transmit generate, for transmission to the network, a special payload indicating to the network the UL transmissions are to be skipped based on the energy level.

20. An apparatus of a user equipment (UE), the apparatus comprising processing circuitry configured to:
decode, based on signals signaling received from a network, a first configuration for wireless communications with the network, wherein the wireless communications and associated processes are performed by a wireless communications module of the UE and powered by energy generated by an energy harvesting module of the UE;
configure transceiver circuitry to transmit generate, for transmission to the network, assistance information to the network including recommended or desired configuration parameters for the wireless communications; and
decode, based on signals signaling received from the network, a second configuration including a suspension or adjustment of some or all of the wireless communications in accordance with one or more of the recommended or desired configuration parameters.
